(19) United States
(12) Patent Application Publication
(10) Pub. No.: US 2007/0219810 A1
(43) Pub. Date: Sep. 20, 2007

(54) PERSONAL PROFILE-BASED PRIVATE CIVIL SECURITY SUBSCRIPTION METHOD

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/279,333

(22) Filed: Apr. 11, 2006

Related U.S. Application Data
(63) Continuation-in-part of application No. 11/394,350, filed on Mar. 30, 2006.
Application No. 11/394,350 is a continuation-in-part of application No. 11/384,037, filed on Mar. 17, 2006.

(51) Int. Cl. G06Q 10/00; G06Q 30/00

(52) U.S. Cl. 705/1

(57) ABSTRACT

Consideration-based private civil security subscriptions are offered (101) to candidate subscribers with respect to providing civilly-catastrophic event-based access to at least one life-sustaining resource. Personal profiles are established (104) for at least some candidate beneficiaries of such a subscription and those personal profiles are used (105) to determine the consideration to be received in exchange for a given subscription on behalf of a given candidate authorized beneficiary. By one approach these personal profiles comprise information regarding the candidate authorized beneficiary's likely personal response to a civilly-catastrophic event and/or the candidate authorized beneficiary's likely ability to respond cooperatively in an emergency situation with respect to obtaining the civilly-catastrophic event-based access to the at least one life-sustaining resource. By one approach such information can comprise information that reflects past training, experience, and/or behaviors (103 and 104). Such information may also comprise information derived from specific testing in this regard (103 and 104).

### RELATED APPLICATIONS

This comprises a continuation-in-part of:
an earlier filed patent application entitled SUBSCRIPTION-BASED PRIVATE CIVIL SECURITY FACILITATION METHOD as filed on Mar. 17, 2006 and having application Ser. No. 11/384,037; and
an earlier filed patent application entitled SUBSCRIPTION-BASED CATASTROPHE-TRIGGERED MEDICAL SERVICES FACILITATION METHOD as filed on Mar. 30, 2006 and having application Ser. No. 11/394,350;
   the contents of which are fully incorporated herein by this reference.

### TECHNICAL FIELD

This invention relates generally to providing survival-related services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:
transportation infrastructure such as roads, bridges, railways, and so forth that facilitate the inexpensive and rapid movement of sometimes perishable goods from source to consumer;
communications infrastructure such as telephones, television, radio, and the Internet that facilitate the inexpensive and rapid sharing of news, advice, information, and entertainment; and
the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs. To a large extent one may reasonably argue that governments have forsaken their responsibility to design, fund, implement, or even discuss an effective civil defense program capable of protecting large segments of their populations.

At the same time, however, it must be admitted that numerous challenges present themselves to anyone seeking to provide an effective civil security option. As but one example in this regard, civilly-catastrophic events generally, almost by definition, potentially impact a relatively large number of people. People, however, are different from one another; they differ with respect to their strength and intelligence, their experience and skills, their physical and mental abilities, their regard or disregard for others, their selfishness or altruism, and their ethics, to note but a very few salient examples. Such differences can come into play as a civilly-catastrophic event is likely to be met by a bewildering breadth of individual responses. In particular, it is likely that some, or even many, individuals will act in a manner that is contrary to their own short and/or long term survival. It is also possible that some individuals will act in a manner that renders it more difficult to ensure the short and/or long term survival of others.

### BRIEF DESCRIPTION OF THE DRAWINGS

The above needs are at least partially met through provision of the personal profile-based private civil security subscription method described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram view as configured in accordance with various embodiments of the invention; and

FIG. 4 comprises a top plan block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, consideration-based private civil security subscriptions are offered to candidate subscribers with respect to providing civilly-catastrophic event-based access to at least one life-sustaining resource. Personal profiles are established for at least some candidate beneficiaries of such a subscription and those personal profiles are used to determine the consideration to be received in exchange for a given subscription on behalf of a given candidate authorized beneficiary.

By one approach these personal profiles comprise information regarding the candidate authorized beneficiary's likely personal response to a civilly-catastrophic event and/or the candidate authorized beneficiary's likely ability to respond cooperatively in an emergency situation with respect to obtaining the civilly-catastrophic event-based access to the at least one life-sustaining resource. By one approach such information can comprise information that reflects past training, experience, and/or behaviors. By one approach such information may also comprise information derived from specific testing in this regard.

Generally speaking, these personal profiles serve to inform, to at least some degree, a sense of how easy, or how difficult, it will likely be to in fact provide the aforementioned civilly-catastrophic event-based access to life-sustaining resources. When the personal profile for a given individual suggests greater than average difficulty in this regard, for example, a relatively higher consideration can be required for this subscription. When, on the other hand, the personal profile for a given individual suggests relative ease in this regard, a relatively lower consideration might be applied for such a subscription.

So configured, the pricing and/or other elements of a private civil security mechanism can take into account and hence reflect the relative difficulty of providing effective services in this regard to specific individuals. This, in turn, can aid with respect to ensuring that all authorized beneficiaries are in fact provided with adequate services in the event of a civilly-catastrophic event. In particular, such services are ultimately more likely to be effectively gauged to correspond to the individual needs, abilities, and proclivities of individual beneficiaries. These steps are facilitated without dependency upon governmental oversight, participation, or control. The particular resources provided can vary with the needs and requirements of the authorized beneficiaries as informed, at least in part, by their personal profiles.

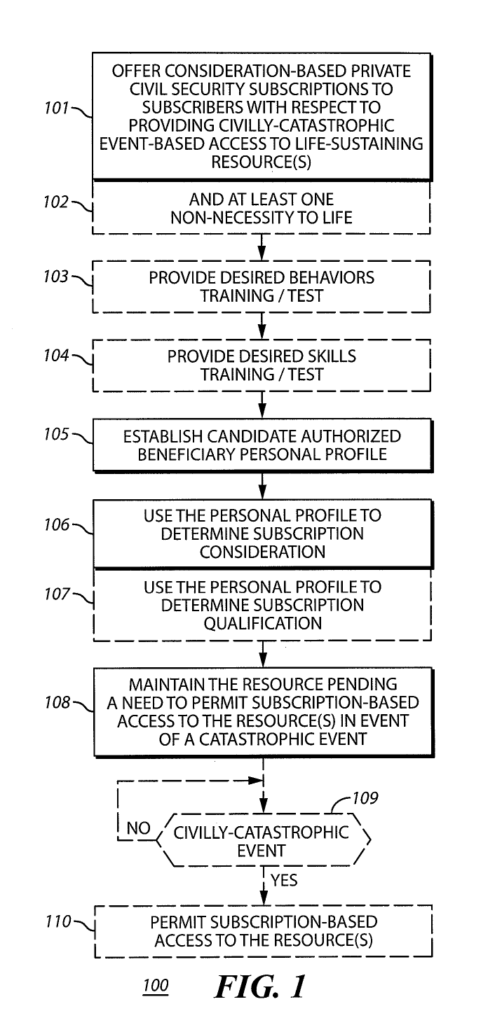

These and other benefits may become clearer upon making a thorough review and study of the following detailed description. Referring now to the drawings, and in particular to FIG. 1, these teachings provide generally for offering 101 consideration-based private civil security subscriptions to subscribers with respect to providing civilly-catastrophic event-based access to at least one life-sustaining resource (or, if desired, to a plurality of different kinds and/or categories of life-sustaining resources) such as, but not limited to, resources pertaining to hydration, nourishment, shelter, environmentally borne threat abatement (such as protection from chemical, biological, and/or radioactive threats and the like), clothing, physical security, transportation, and/or rescue services. This life-sustaining resource (or resources) can comprise, for example, a consumable necessity of human life (i.e., a necessity such as nourishment that tends to be reduced in supply as it is consumed) and/or a non-consumable necessity of human life (i.e., a necessity such as shelter that is not necessarily reduced in supply as it is applied or used).

This right of access can pertain, if desired, to a predetermined quantity of the life-sustaining resource. For example, a given subscription can relate to providing access to a one year's supply of the at least one life-sustaining resource for a given individual, number of individuals, or the like.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights in the at least one life-sustaining resource);

non-transferable rights of access (as may occur when the subscription, by its terms and conditions, prohibits transfer of the right of access to the at least one life-sustaining resource from a first named beneficiary to another);

transferable rights of access (as may occur when the subscription, by its terms and conditions, permits conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one life-sustaining resource); and/or

non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing life-sustaining resource supplies. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing life-sustaining resources that, though nutritionally viable, are economically selected while another subscription might provide for life-sustaining resources that are more costly and in turn reflect, for example, a wider variety of choices within a given category of resource. As will be shown below, there are also other bases by which the pricing of a given subscription for a given authorized beneficiary may be ascertained or at least influenced.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to one or more life-sustaining resources in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as intentional acts of war, terrorism, madness, or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

In addition to offering 101 a subscription with respect to providing civilly-catastrophic event-based access to one or more consumable or non-consumable life-sustaining resources, a given subscription may also provide for similar access to at least one non-necessity 102 (that is, an item or service that is not, strictly speaking, necessary to sustain human life on an elemental basis). This can certainly comprise providing a right of access to a plurality of non-necessities if desired. An illustrative listing of representative non-necessities comprises, but is certainly not limited to:

a luxury consumable (such as, for example, alcoholic beverages, foods that provide an experience beyond simple survival, and so forth);

a luxury non-consumable;

clothing;

a food preparation tool;

a personal communication device;

a personal hygiene item;

non-human nourishment (such as dog food, cat food, and so forth);

barter medium (such as bulk or coined precious metals including but not limited to gold, silver, and so forth);

an electrical energy source (including but not limited to alternating current power sources, direct current power sources, fuel-consumptive power sources, renewable fuel source power sources, and so forth);

an entertainment apparatus (such as game stations, musical instruments, reading material, and so forth);

an educational tool (including but not limited to instructional texts, reference works, laboratory and demonstrative equipment, and so forth);

physical conditioning, exercise, and maintenance training and equipment;

repair and maintenance tools and services;

crafts supplies and training; and/or

sports equipment and facilities;

to note but a few examples.

This process 100 then provides for establishing 105 a personal profile for at least one candidate authorized beneficiary of one of these subscriptions. More typically, each (or at least many) such candidate authorized beneficiary will be the subject of such a personal profile. In many cases this personal profile may comprise information regarding the candidate authorized beneficiary's likely personal response to an emergency situation (such as, but not necessarily limited to, a civilly-catastrophic event). This might comprise, depending upon the application context, information regarding (but not necessarily limited to) a personal history of violence, military service, emergency services employment, emergency services training, medical services employment, medical services training, law enforcement service, law enforcement training, mental health, quantified intelligence (as represented, for example, by an intelligence quotient score), physical mobility capability, an assessed response to stressful circumstances, assessed anxieties, and/or assessed levels of self confidence, to name but a few.

As another example, these personal profiles can comprise, at least in part, information regarding the candidate authorized beneficiary's likely ability (as distinct from, for example, inclination or motivation) to respond cooperatively in an emergency situation with respect to obtaining the civilly-catastrophic event-based access to the at least one life-sustaining resource. This might comprise, again depending upon the application context, information such as (but not necessarily limited to) athleticism, physiological condition, mental acuity, theological convictions and/or practices, family ties, demonstrated skills, training, physical mobility capability, and/or gender, again to name but a few.

As yet another example, these personal profiles can comprise, at least in part, information regarding the candidate authorized beneficiary's likely ability to personally respond cooperatively in an emergency situation beyond merely obtaining their own civilly-catastrophic event-based access to the at least one life-sustaining resource. To illustrate, such information might comprise information regarding the candidate authorized beneficiary's likely behavior with respect to assisting other authorized beneficiaries in response to a civilly-catastrophic event and/or their likely ability to provide, in fact, useful assistance to such persons under such circumstances. As another illustrative example, such information could comprise information regarding the candidate authorized beneficiary's likely ability to provide useful assistance with respect to providing at least one life-sustaining service and/or at least one valued life-enhancing service following a civilly-catastrophic event (by reflecting, for example, the candidate authorized beneficiary's demonstrated skill set in these or other regards).

There are various ways by which such a personal profile can be established 105. By one approach the information can be acquired by way of a questionnaire and/or interview process (where the person being queried may comprise the candidate authorized beneficiary themselves, a candidate subscriber when the subscriber seeks to establish such a subscription on behalf of the candidate authorized beneficiary, or any other party as may have such information in their possession). By another approach this information may be gleaned, at least in part, via one or more background checks. This could comprise, for example, reviewing criminal, police, and litigation records, medical records, insurance records, published sources, and so forth.

By another approach, if desired, testing of the candidate authorized beneficiary with respect to one or more circumstances, conditions, or criteria as regards one or more desired behaviors can optionally be provided 103. By one approach, this testing can be accompanied by corresponding desired behaviors training; for example, the candidate authorized beneficiary can undergo training with respect to one or more desired behaviors and the testing can then serve to determine a degree to which the candidate has properly assimilated that training. By yet another approach, this information can comprise information regarding an individual's actual behavior with respect to an actual civilly-catastrophic event. Such information might reflect, for example, the individual's actual behavior when at least attempting to make subscription-based civilly-catastrophic event-based access to a life-sustaining resource as per an earlier survived civilly-catastrophic event.

By another approach, if desired, testing of the candidate authorized beneficiary with respect to one or more circumstances, conditions, or criteria as regards one or more desired skills can also optionally be provided 104. By one approach, this testing can be accompanied by corresponding desired skills training; for example, the candidate authorized beneficiary can undergo training with respect to one or more desired skills and the testing can then serve to determine a degree to which the candidate has properly assimilated that training.

There are various ways to carry out such testing and/or training. As just one example, virtual reality techniques can be used to effect such testing/training. Virtual reality techniques of various kinds are known in the art and others will no doubt be developed hereafter. Such techniques can serve, for example, to present a candidate authorized beneficiary with a simulated civilly-catastrophic event and its corresponding problems and challenges. The responses of the candidate authorized beneficiary to such challenges can then serve as insight into their personal skills and/or behaviors and proclivities in this regard. It is also possible to use such an approach to present candidate authorized beneficiaries with effective training regarding desired behaviors and practices to exhibit with respect to obtaining their civilly-catastrophic event-based access to their subscribed-to life-sustaining resource(s).

This process 100 then provides for using 106 these personal profiles to determine the consideration to be received in exchange for the subscription on behalf of the corresponding candidate authorized beneficiary. By one approach this can comprise determining the consideration to be received from the subscriber prior to the civilly-catastrophic event (upon initial entry of the subscription, for example, or during some regular payment period as may pertain thereto). By one approach, if desired, this personal profile can be used to determine an amount of previously received monetary consideration to be returned to the subscriber (as may be appropriate, for example, when a given authorized beneficiary completes relevant training subsequent to initiation of the subscription to acquire and demonstrate proficiency with respect to one or more desired skills and/or desired behaviors management).

This usage 106 can comprise, for example, requiring a relatively higher amount of consideration when the personal profile indicates that the candidate authorized beneficiary will likely be less than fully cooperative and/or less than fully capable of cooperation in an emergency situation as will likely attend a civilly-catastrophic event. Similarly, if desired, this usage 106 can comprise requiring a relatively lower amount of consideration when the personal profile indicates that the candidate authorized beneficiary will likely be relatively cooperative in these regards under such circumstances.

If desired, in addition to such usage 106 or in lieu thereof, the personal profile can be used 107 to determine whether a particular candidate authorized beneficiary qualifies to receive a subscription that provides a particular life-sustaining resource. For example, the life-sustaining resource may comprise a civilly-catastrophic event-based rescue service. When the personal profile indicates that a particular candidate authorized beneficiary presents too great a risk to both themselves and the rescue service personnel due to their particular lack of skills and/or behavioral tendencies, a determination may be made that such a service will not be offered to this individual for any amount of consideration.

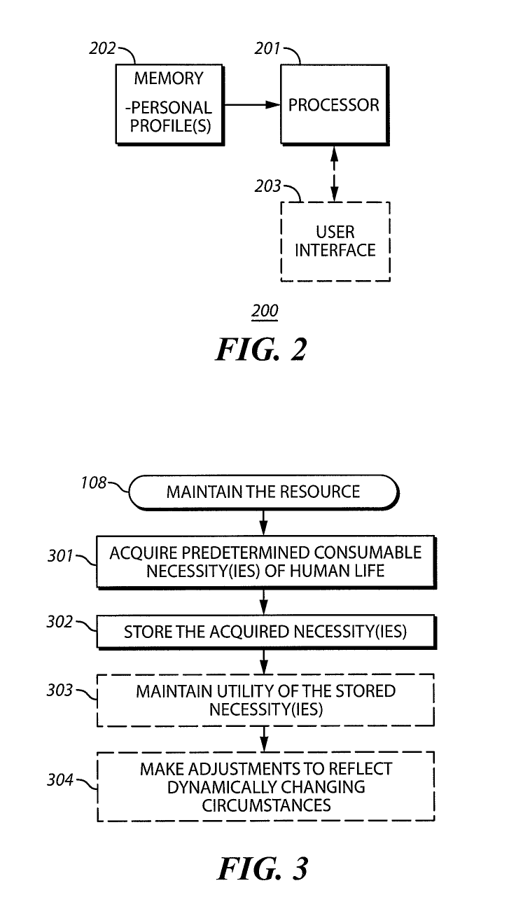

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring momentarily to FIG. 2, an illustrative approach to such a platform will now be provided.

This illustrative system 200 comprises a processor 201 that operably couples to a memory 202 and, optionally, to a user interface 203 of choice. The processor 201 may comprise any computational platform of choice including but not limited to a so-called personal computer. In general, it will probably be preferred that the processor 201 comprise a programmable platform. In any event, this processor 201 is configured and arranged (via, for example, corresponding programming) to carry out at least selected portions of the teachings as have been set forth above. In this regard the memory 202 serves, at least in part, to store and retain the aforementioned personal profiles. So configured, the process 201 has ready access to such personal profile information and can use that information to establish subscription consideration and/or subscription qualification. The user interface 203 provides a mechanism for receiving input from a user (including but not limited to personal profile information, candidate authorized beneficiary information, subscriber information, and so forth) and for imparting output to a user.

Those skilled in the art will recognize and understand that such an apparatus may be comprised of a plurality of physically distinct elements as is suggested by the illustration shown in FIG. 2. It is also possible, however, to view this illustration as comprising a logical view, in which case one or more of these elements can be enabled and realized via a shared platform.

Referring again to FIG. 1, this process 100 can then optionally provide for maintaining 108 the resource(s) pending detection 109 of a triggering civilly-catastrophic event and a corresponding need to permit 110 subscription-based access to the resource(s) in response to the occurrence of a catastrophic event. This, of course, can comprise maintaining the resource on behalf of the subscriber and/or on behalf of another authorized beneficiary. The specifics of such maintenance will of course vary with respect to the nature of the resource or resources being maintained.

As one example, and referring momentarily to FIG. 3, when the resource (or resources) comprise one or more predetermined consumable necessities of human life, maintaining 108 the resource can comprise acquiring 301 the at least one predetermined consumable necessity of human life to thereby provide acquired necessities and then storing 302 those acquired necessities to thereby provide stored necessities that are held on behalf of the corresponding authorized beneficiaries pending a need to access those stored necessities in the event of a triggering civilly-catastrophic event. These acquisition and storing steps can further comprise, if desired, acquiring and storing non-consumable necessities of human life and/or consumable or non-consumable non-necessities of human life.

If desired, some or all of the particular items so acquired and stored can reflect, partially or wholly, the information contained in the personal profile for a given authorized beneficiary. As one simple illustration, a given authorized beneficiary may be quite bereft of certain skills as pertain to food preparation. In such a case, the particular items acquired and stored for this particular authorized beneficiary can reflect a corresponding accommodation. For example, consumable food items may represent a reasonable compromise regarding palatability and nutritional value on the one hand and ease of preparation requirements on the other hand.

Acquisition 301 of such items can be achieved through any of a variety of means. By one approach the items may be procured on the open market. By another approach the items may be purchased or otherwise acquired from third parties via private negotiations. By yet another approach the entity that provides and accepts these subscriptions may itself create (through manufacturing, farming, or the like) the items of interest. In some cases the acquired item may comprise a staple of ordinary commerce. In other cases the acquired item may be unique and/or proprietary to the acquiring/storing entity.

By one approach such storage 302 occurs through use of one or more storage facilities 300 that are owned or controlled by the subscription accepting entity. Any suitable storage facility may be used for this purpose with examples comprising (but not being limited to) above ground man-made shelters, below ground or below water facilities (including purposefully excavated facilities, natural caverns, and so forth), and water borne facilities (such as barges and the like). Each such storage facility will likely serve to store the resources as correspond to a plurality of authorized beneficiaries. By one approach such resources are stored in the aggregate. By another approach, or in combination with an aggregated approach, some or all of the acquired necessities are stored in subscriber-based bundles. For example, each such bundle can comprise a one year supply of all acquired items for a single adult authorized beneficiary. As another example, such a bundle could comprise a one year supply of all acquired items as are intended for a family of four authorized beneficiaries. Individualized storage facilities, of course, may be quite appropriate when the stored items themselves reflect a partially or wholly customized assortment as corresponds to particular authorized beneficiaries.

Other possibilities of course exist. For example, a single authorized beneficiary may have a first bundle comprised of staple items that are acquired and stored for all beneficiaries and a second bundle comprised of custom items that are specifically and uniquely acquired for this particular beneficiary or class of beneficiaries (such as beneficiaries who all share a common dietary ailment or condition, sensitivity, medical condition, preference, or the like).

The bundle itself can be realized via any of a wide variety of encapsulating or restraining mechanisms. For example, a tarp and tie-downs can be used to segregate the goods and form the described bundle. As another example, discrete storage cabinets formed of wood, metal, plastic, canvas, or other material of choice could be employed for this purpose. Shrink wrap materials could also be employed in this regard. In addition, if desired, these bundles can be individually palletized (i.e., each placed upon and optionally secured to a pallet). Palletization, in turn, will permit ready and efficient movement of such bundles to, about, or from a given storage facility and/or delivery of such a bundle to an authorized beneficiary when such delivery comprises the desired form of granting access to such resources.

By one approach these teachings may further comprise maintaining 108 the resource in such a context can further optionally comprise maintaining 303 the utility of the stored necessities. This can comprise, for example, monitoring the usability of perishable items and replacing such items on a corresponding schedule. As another simple illustration this step 303 can comprise holding certain items in deep refrigeration or in other special storage conditions as may suit the proper maintenance of such items. Of course, when special and/or relatively more costly storage requirements are necessary to properly store the resources being held for a given authorized beneficiary, this increased cost can be reflected in a relatively higher consideration requirement for the subscription for that particular authorized beneficiary.

Such maintenance 108 can also optionally comprise making adjustments 304 to the stored necessities to reflect dynamically changing circumstances as occur during the consideration-based private civil security subscription period. As one illustration, a new product may become available that is particularly useful in treating a particular infectious condition that may likely arise upon the occurrence of a particular kind of civilly-catastrophic event. In such a case, maintaining 108 such resources can readily accommodate updating the acquired and stored items to include a supply of this new product. Accordingly, this step of making adjustments 304 can readily comprise one or more of removing a particular one of the stored necessities (as when a better substitute becomes available, when the stored necessity itself is shown to be less effective for its intended purpose than was originally thought, and so forth), adding additional ones of the stored necessities (as when it becomes subsequently understood that more of a particular item is desirable to achieve a particular survival-related goal or purpose), adding at least one new stored necessity that is not already stored (as illustrated in the example provided above), and so forth.

As another illustrative example, it may be useful and/or necessary to make such an adjustment to reflect changing circumstances with respect to the personal profile for a given authorized beneficiary. As one example, during the course of a given subscription term a given authorized beneficiary may acquire one or more desired skills and/or may be able to demonstrate amelioration or mitigation of a previously noted undesirable behavior. This, in turn, can lead to a corresponding adjustment with respect to the resources as have been acquired and stored for this particular authorized beneficiary. To continue the illustrative example presented above, if special low-preparation-requirements foods had been acquired for a given authorized beneficiary, and the latter has now acquired useful food preparation skills via appropriate and vetted training, lower cost preparation-required foods can now be substituted for the previously acquired low-preparation-requirements food.

In the examples provided above, the resource being acquired and maintained comprises consumable or non-consumable items. As noted earlier, however, these teachings are applicable for use with other resources as well. For example, maintaining 108 the resource may relate to providing civilly-catastrophic event-based access to a shelter. By this approach this step of maintaining 108 the resource can comprise maintaining such a shelter.

Much is known in the art regarding construction and maintenance of shelters. Such a construction will usually at least serve to protect the inhabitants from environmental stress and extremes. In addition to walls and a roof such a shelter will typically also comprise internal temperature control, lighting, storage facilities, sleeping facilities, food preparation facilities, personal hygiene facilities, and so forth. For present purposes such a shelter may also be equipped to provide for water treatment (such as filtering, bacteria removal, and so forth), waste treatment and/or recycling, electrical power generation, and/or air treatment (including but not limited to conditioning, filtering, and so forth). By one approach such a shelter can also be equipped with communication facilities including a variety of wireless broadcast capabilities, long-distance two-way communications capabilities, and so forth.

By yet another approach, such a shelter can provide private safe deposit box service for the authorized beneficiaries. This, in turn, would permit beneficiaries to pre-provision such a shelter with certain personal items of their choice and/or to have a safe place to store their own valuables upon arriving at the shelter during times of need. Such an approach can serve, for example, as a way of providing relatively unique, costly, and/or personnel items in reserve for particular authorized beneficiaries.

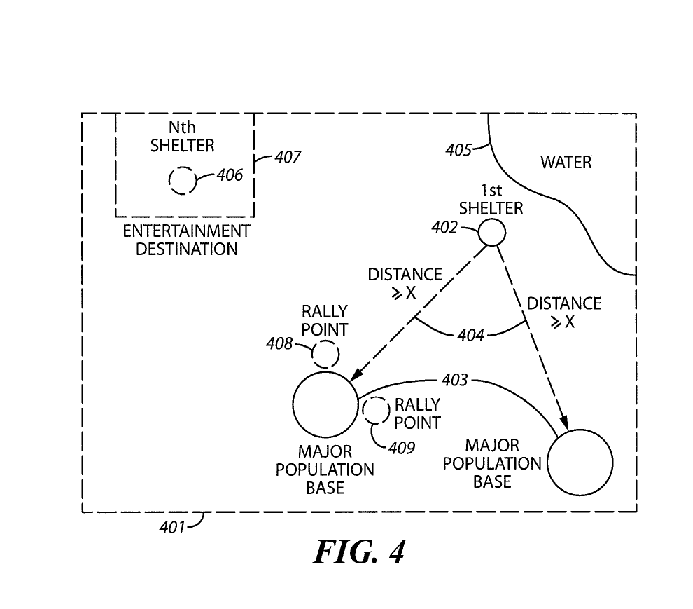

Security will likely comprise a primary concern for such a shelter. In particular it will likely be important to secure the shelter, any resources as are stored or otherwise available at the shelter, and the inhabitants of the shelter from unauthorized entry and access. By one approach, this can comprise maintaining the shelter in a location that is substantially distal from a nearest substantial human population. For example, and referring momentarily to FIG. 4, within a given geographic region 401 (such as a continent, country, or the like) a shelter 402 may be separated from the closest major population bases 403 by a distance that at least exceeds some predetermined substantial distance X 404. Depending upon other factors, this distance X might comprise, for example, 800 kilometers. Other factors might well play a part in this regard, of course. For example, a significant natural barrier (such as a large mountain range) might lie between a major population base and a shelter and make reasonable a shorter separation distance between such entities.

When possible, and with continued reference to FIG. 4, it may be desirable to locate such a shelter 402 in relative proximity to a water source 405. A suitable water source 405 can comprise a ground-level water source or an underground water source as, in either case, ready access to the water source may be available. This, in turn, can be useful with respect to ensuring an adequate supply of water for the inhabitants of the shelter 402 in times of need. A ground-level water source may also provide a means of ingress and egress to facilitate the comings and goings of the authorized beneficiaries (for example, a navigable waterway can provide an effective pathway by which to transport at least some authorized beneficiaries to the shelter 402).

Notwithstanding that it may be desirable to locate such shelters at a considerable distance from major population centers, this does not necessarily require that such shelters be secreted within completely primitive and/or wild settings. For example, one useful approach might be to locate such a shelter 406 proximal to an entertainment destination 407 (such as, but not limited to, remotely located golf courses, resorts, dude ranches, casinos, and so forth). In such a case at least some of the infrastructure that may be required and/or useful for the shelter can be shared with the facilities of the entertainment destination and thereby reduce the effective costs of installing and maintaining such facilities.

For a variety of reasons it may be appropriate to provide a plurality of such shelters in various locations throughout a relatively wide geographic region such as a continent or country. Such a dispersal can aid with reducing the logistic difficulties of transporting authorized beneficiaries to such a shelter during times of need. Dispersed shelters can also help ensure that at least some shelters will more likely survive civilly-catastrophic events that pose sufficient destructive force to destroy such a shelter.

When providing a plurality of shelters, it may also be useful to differentiate such shelters from one another with respect to, for example, their features and/or accouterments. Such shelters may be differentiated, for example, with respect to their relative support for such things as a maximum supportable population, a depth and breadth of provided non-essential accouterments of life, medical facilities (such as, but not limited to, specialized equipment such as respirators, dialysis equipment, operating facilities, and so forth), pet animal accommodations, risk threat abatement capability, entertainment facilities, and so forth. Assignment and/or access to a given differentiated shelter can be determined, at least in part, by such things as relative initial proximity of the authorized beneficiary, the terms and conditions of the corresponding subscription agreement, and so forth.

Notwithstanding the benefits of locating such shelters a considerable distance from major population centers, there may be times when such a distance presents undue problems in and of itself. Such concerns can particularly present themselves when confronted with the need to transport especially needy authorized beneficiaries to such a shelter in response to a civilly-catastrophic event. In such a case, it may be desirable to place at least one such shelter in relatively close proximity to such a population base in order to reduce, perhaps considerably, the logistical challenge of transporting and/or receiving a given authorized beneficiary at the shelter. In many cases, of course, such proximity will exacerbate many of the previously mentioned concerns regarding security and the like. The increased consideration as may be required of a special needs authorized beneficiary, however, should offset the increased expenses of overcoming such problems.

By one approach these teachings can be simply practiced by provision of shelter and/or life-sustaining supplies; gaining physical access to such resources comprises the responsibility of the authorized beneficiaries. During such times, of course, it can be expected that civil conditions will be troubled and confusing. Therefore, by another approach these teachings can further encompass transporting at least some of the authorized beneficiaries to the shelter and/or supplies in response to the occurrence of a civilly-catastrophic event. There are various ways by which to accomplish such a task.

By one optional approach at least one rally point 408 can be identified. Such a rally point need not be reserved only for this purpose and may, for example, simply comprise a convenient location for at least some authorized beneficiaries. Example rally points might include sports stadiums and auditoriums, amusement parks, and the like. When possible, it may be helpful to locate such a rally point relatively near an airstrip and/or a navigable waterway. Such amenities, in turn, can potentially be used when transporting the gathered beneficiaries to their destination (as when, for example, a destination shelter is accessible from the navigable waterway that is also readily accessible from the rally point).

By one approach, one or more such rally points can be identified for each larger population area that contains authorized beneficiaries. It would also be possible, of course, to identify rally points to serve a similar function in more rural settings as well if desired. It may also be useful to identify at least one rally point (such as the rally point denoted by reference numeral 409) as a rally point for increased-needs or minimal-needs authorized beneficiaries. In such a case, the amenities and/or transport modality provided at such a rally point 409 can vary accordingly from the norm to reflect such special considerations.

It would also be possible to use personal profile information to assign a useful mix of individuals to a given rally point. As but one example, an authorized beneficiary having a particular skill may be assigned to a same rally point as another authorized beneficiary having a need for the availability of this particular skill. In such a case, of course, the special needs authorized beneficiary can be assessed a higher subscription consideration while the special skills beneficiary might be assessed a relatively lower subscription consideration in accordance with these teachings.

This process can optionally provide information regarding such rally points to the authorized beneficiaries. This information can be provided prior to the occurrence of a civilly-catastrophic event if desired. It may also be useful or possible to provide such information (either in the first instance or as a supplemental notice) following the initiation of such an event. The latter may be achieved using such communication means as may be available at the time. It would also be possible to provision each authorized beneficiary (or family or company of beneficiaries) with one or more communications devices by which such information could be provided. This process could then provide appropriate transportation to move the authorized beneficiaries from these rally points to the destination (such as to a designated shelter).

In many instances such transportation can comprise standard vehicles (cars, buses, boats, airplanes, railroad cars, and so forth). If desired, however, more specialized equipment could be used including but not limited to armored transports, environmentally-contained vehicles or trailers, and so forth. Again, to the extent that special needs for a given authorized beneficiary drive the need to make such specialized equipment available, the consideration assessed for a subscription for such an individual can be relatively increased.

These teachings can readily accommodate other features as well. For example, prior to the occurrence of a civilly-catastrophic event an authorized beneficiary can be provided with a short-term survival kit to facilitate their survival prior to their being able to access the aforementioned stored necessities upon the occurrence of a civilly-catastrophic event. Such a short-term survival kit might comprise, for example, a seven day supply of nourishment, clothing, food preparation items, bedding, navigation tools, communication tools and/or location beacons, first aid supplies, water treatment items, items to aid with protecting against or otherwise treating environmentally borne hazards, maps, portable power sources, fire starting equipment, survival instructions, and so forth. In some cases, when appropriate, the contents of this short-term survival kit can be modified to reflect the contents of a given authorized beneficiary's personal profile.

As another example, authorized beneficiaries could be provided with a survival instruction guide kit. These instructions could provide information regarding survival practices, emergency responses, and so forth. By one approach each authorized beneficiary who comprised a part of a shared group (such as a family group, a company group, and so forth) would receive such a kit. This, in turn, would facilitate unity of action, purpose, and result in the event of a civilly-catastrophic event. For example, by each knowing and observing the shared instructions provided by such an approach, the participants would be able to take their own coordinated actions while being relatively secure in their knowledge of what their group counterparts were also likely doing at that time.

This survival instruction guide kit could comprise, for example, a book or manual having printing survival instructions and information in combination with fill-in-the-blank opportunities whereby a given authorized beneficiary could customize the instructions to specifically suit their particular needs and situation. Such blanks could be used, for example, to prompt the beneficiary to think through and to record information such as their primary and secondary rally points or other family/group meeting points and protocols, communications protocols and contact information, specific items (perhaps somewhat unique to the individual and which may, or may not, relate to the survival of that individual) that should be stockpiled or otherwise made readily available in the event of a civilly-catastrophic event, and so forth. Such a book or manual could include indexes, tabs, or other navigation tools to permit a reader to quickly find the relevant information they require during a time of need.

By one approach, the creation, in whole or in part, of such a survival instruction guide kit can reflect the personal profile for a given authorized beneficiary. For example, in a case where the personal profile for a given authorized beneficiary indicates particular concerns regarding the authorized beneficiary's specific personal ability and/or native inclination to effect particular desired actions in times of need, the survival instruction guide kit may be modified to specifically reflect these concerns. This might comprise, for example, providing instructions that, while perhaps less than theoretically optimal, are more likely to be carried out by this particular individual and are hence, on balance, a better choice to present in this manner. As one illustrative extreme in this regard, a particularly needy authorized beneficiary might be provided with a two-way communications device to provide continual access to a live operator who can provide specific verbal instructions, encouragement, and so forth to the authorized beneficiary in times of need. Again, consistent with these teachings, the consideration required to instantiate such a subscription for such an individual may be relatively higher than for the average subscriber.

These teachings would also accommodate providing survival training to authorized beneficiaries. Such training could comprise in-person, on-site training, live instructors, and/or previously prepared teaching resources such as, but not limited to, electronic learning resources. This training could include both general information regarding specific do's and don'ts as pertain to different kinds of civilly-catastrophic events as well as more specific information regarding specific actions that should be taken by the authorized beneficiary with respect to successfully achieving access to their subscribed-to resources as per their subscription.

These teachings will also accommodate providing authorized beneficiaries with a corresponding authorization mechanism by which they can effect their right of access to the resources provided by their subscription. This may comprise a mechanism that the beneficiary carries with them as personal property (such as an identification card) or, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of surviving a civilly-catastrophic event. These teachings are sufficiently flexible so as to accommodate the needs and desires of a wide-ranging set of potential beneficiaries while nevertheless still tending to ensure adequate access to the basic necessities of life. Though training and some related activity may be provided and encouraged, in general the beneficiary receives these benefits without being required to make the commitment of time, energy, and expertise that would ordinarily be associated with attaining such a high level of civil security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
offering consideration-based private civil security subscriptions to subscribers with respect to providing civilly-catastrophic event-based access to at least one life-sustaining resource wherein at least some of the subscriptions potentially vary from one another at least with respect to the consideration to be received in exchange for the subscription;
establishing a personal profile for at least one candidate authorized beneficiary of one of the subscriptions;
using the personal profile to determine the consideration to be received in exchange for the subscription on behalf of the at least one candidate authorized beneficiary.

2. The method of claim 1 wherein establishing a personal profile comprises, at least in part, obtaining information regarding the candidate authorized beneficiary's likely personal response to an emergency situation.

3. The method of claim 2 wherein obtaining information regarding the candidate authorized beneficiary's likely personal response to an emergency situation comprises obtaining information regarding the candidate authorized beneficiary's likely personal response to a civilly-catastrophic event.

4. The method of claim 2 wherein obtaining information regarding the candidate authorized beneficiary's likely personal response to an emergency situation comprises obtaining information for the candidate authorized beneficiary regarding at least one of:
a personal history of violence;
military service;
emergency services employment;
emergency services training;
medical services employment;
medical services training;
law enforcement service;
law enforcement training;
mental health;
quantified intelligence;
physical mobility capability;
assessed response to stressful circumstances;
assessed anxieties;
assessed self confidence.

5. The method of claim 1 wherein establishing a personal profile comprises, at least in part, obtaining information regarding the candidate authorized beneficiary's likely ability to respond cooperatively in an emergency situation with respect to obtaining the civilly-catastrophic event-based access to the at least one life-sustaining resource.

6. The method of claim 5 wherein obtaining information regarding the candidate authorized beneficiary's likely ability to respond cooperatively in an emergency situation with respect to obtaining the civilly-catastrophic event-based access to the at least one life-sustaining resource comprises obtaining information regarding at least one of the candidate authorized beneficiary's:
athleticism;
physiological condition;
mental acuity;
theological convictions;
theological practices;
family ties;
demonstrated skills;
training;
physical mobility capability;
gender.

7. The method of claim 3 wherein using the personal profile to determine the consideration to be received in exchange for the subscription on behalf of the at least one candidate authorized beneficiary comprises requiring a relatively higher amount of consideration when the information indicates that the candidate authorized beneficiary will likely be less than fully cooperative in the emergency situation with respect to obtaining the civilly-catastrophic event-based access to the at least one life-sustaining resource.

8. The method of claim 3 wherein using the personal profile to determine the consideration to be received in exchange for the subscription on behalf of the at least one candidate authorized beneficiary comprises requiring a relatively lower amount of consideration when the information indicates that the candidate authorized beneficiary will likely be relatively cooperative in the emergency situation with respect to obtaining the civilly-catastrophic event-based access to the at least one life-sustaining resource.

9. The method of claim 1 wherein establishing a personal profile comprises, at least in part, obtaining information regarding the candidate authorized beneficiary's likely ability to personally respond cooperatively in an emergency situation beyond merely obtaining their own civilly-catastrophic event-based access to the at least one life-sustaining resource.

10. The method of claim 9 wherein obtaining information regarding the candidate authorized beneficiary's likely ability to personally respond cooperatively in an emergency situation beyond merely obtaining their own civilly-catastrophic event-based access to the at least one life-sustaining resource comprises, at least in part, obtaining information regarding at least one of:
the candidate authorized beneficiary's likely behavior with respect to assisting other authorized beneficiaries in response to a civilly-catastrophic event;
the candidate authorized beneficiary's likely ability to provide useful assistance to other authorized beneficiaries in response to a civilly-catastrophic event;
the candidate authorized beneficiary's likely ability to provide useful assistance with respect to providing access to the at least one life-sustaining resource;
the candidate authorized beneficiary's likely ability to provide useful assistance with respect to providing at least one of a life-sustaining service and a life-enhancing service following a civilly-catastrophic event;
the candidate authorized beneficiary's demonstrated skill set.

11. The method of claim 1 wherein establishing a personal profile for at least one candidate authorized beneficiary of one of the subscriptions comprises, at least in part, testing the at least one candidate authorized beneficiary.

12. The method of claim 11 wherein testing the at least one candidate authorized beneficiary comprises using a virtual reality technique to test the at least one candidate authorized beneficiary.

13. The method of claim 11 wherein testing the at least one candidate authorized beneficiary comprises, at least in part, testing the at least one candidate authorized beneficiary with respect to their participation in training.

14. The method of claim 13 wherein the training comprises training with respect to at least one of experiencing and surviving at least one of a civilly-catastrophic event and a post-civilly-catastrophic event condition.

15. The method of claim 13 further comprising:
providing training to the at least one candidate authorized beneficiary with respect to desired behaviors to exhibit with respect to obtaining the civilly-catastrophic event-based access to at least one life-sustaining resource

16. The method of claim 1 wherein establishing a personal profile for at least one candidate authorized beneficiary of one of the subscriptions comprises, at least in part, acquiring background information regarding the at least one candidate authorized beneficiary.

17. The method of claim 1 wherein using the personal profile to determine the consideration to be received in exchange for the subscription on behalf of the at least one candidate authorized beneficiary comprises using the personal profile to determine the consideration to be received from the subscriber prior to the civilly-catastrophic event.

18. The method of claim 1 wherein using the personal profile to determine the consideration to be received in exchange for the subscription on behalf of the at least one candidate authorized beneficiary comprises using the personal profile to determine an amount of previously received monetary consideration to be returned to the subscriber.

19. The method of claim 1 wherein establishing a personal profile for at least one candidate authorized beneficiary of one of the subscriptions comprises obtaining information regarding the authorized beneficiary's actual behavior with respect to an actual civilly-catastrophic event.

20. The method of claim 19 wherein obtaining information regarding the authorized beneficiary's actual behavior with respect to an actual civilly-catastrophic event comprises obtaining information regarding the authorized beneficiary's actual behavior when at least previously attempting to make subscription-based civilly-catastrophic event-based access to at least one life-sustaining resource.

21. The method of claim 1 further comprising:
maintaining the resource pending a need to permit subscription-based access to the resource in event of a catastrophic event.

22. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

23. The method of claim 1 wherein accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access to a plurality of life-sustaining resources.

24. The method of claim 23 wherein accepting consideration-based private civil security subscriptions from subscribers with respect to providing civilly-catastrophic event-based access to a plurality of life-sustaining resources comprises accepting consideration-based private civil security subscriptions from subscribers with respect to providing civilly-catastrophic event-based access to a plurality of life-sustaining resources as pertain to a plurality of differing categories of life's necessities.

25. The method of claim 21 wherein the at least one life-sustaining resource comprises at least one of:
hydration;
nourishment;
shelter;
environmentally borne threat abatement;
clothing;
physical security.

26. The method of claim 1 wherein the civilly-catastrophic event comprises an event that substantially disrupts society's infrastructure and ability to provide the at least one life-sustaining resource.

27. The method of claim 26 wherein the civilly-catastrophic event is one that persists in substantial form for more than a predetermined period of time.

28. The method of claim 1 wherein accepting consideration-based private civil security subscriptions from subscribers with respect to providing civilly-catastrophic event-based access to at least one life-sustaining resource comprises accepting consideration-based private civil security subscriptions from subscribers with respect to providing civilly-catastrophic event-based access to at least a predetermined quantity of the at least one life-sustaining resource.

29. The method of claim 1 wherein accepting consideration-based private civil security subscriptions from subscribers with respect to providing civilly-catastrophic event-based access to at least one life-sustaining resource further comprises accepting consideration-based private civil security subscriptions from subscribers with respect to providing civilly-catastrophic event-based transport service.

30. The method of claim 29 wherein accepting consideration-based private civil security subscriptions from subscribers with respect to providing civilly-catastrophic event-based access to at least one life-sustaining resource further comprises accepting consideration-based private civil security subscriptions from subscribers with respect to providing civilly-catastrophic event-based rescue service.

31. The method of claim 30 further comprising using the personal profile to determine whether a particular candidate authorized beneficiary qualifies to receive a subscription that provides the civilly-catastrophic event-based rescue service.
